(19) United States
(12) Patent Application Publication
(10) Pub. No.: US 2019/0235871 A1
(43) Pub. Date: Aug. 1, 2019

(54) OPERATION DEVICE AND METHOD OF OPERATING SAME

(71) Applicant: Cambricon Technologies Corporation Limited, Beijing (CN)

(72) Inventors: Yunji CHEN, Beijing (CN); Shaoli LIU, Beijing (CN); Tianshi CHEN, Beijing (CN)

(21) Appl. No.: 16/268,479

(22) Filed: Feb. 5, 2019

Related U.S. Application Data
(63) Continuation-in-part of application No. PCT/CN2017/093161, filed on Jul. 17, 2017.

(30) Foreign Application Priority Data
Aug. 5, 2016 (CN) 201610640115.6

(51) Int. Cl. G06F 9/345; G06F 9/30; G06F 9/38

(52) U.S. Cl. CPC G06F 9/345; G06N 3/04; G06F 9/3838; G06F 9/30036

(57) ABSTRACT

Aspects for processing data segments in neural networks are described herein. The aspects may include a computation module capable of performing operations between two vectors with a limited count of elements. When a data I/O module receives neural network data represented in a form of vectors that includes elements more than the limited count, a data adjustment module may be configured to divide the received vectors into shorter segments such that the computation module may be configured to process the segments sequentially to generate results of the operations.

### CROSS-REFERENCE TO RELATED APPLICATIONS

The present invention is a continuation-in-part of PCT Application No. PCT/CN2017/093161, filed on Jul. 17, 2017, which claims priority to commonly owned CN Application No. 201610640115.6, filed on Aug. 5, 2016. The entire contents of each of the aforementioned applications are incorporated herein by reference.

### ABSTRACT

Aspects for processing data segments in neural networks are described herein. The aspects may include a computation module capable of performing operations between two vectors with a limited count of elements. When a data I/O module receives neural network data represented in a form of vectors that includes elements more than the limited count, a data adjustment module may be configured to divide the received vectors into shorter segments such that the computation module may be configured to process the segments sequentially to generate results of the operations.

### BACKGROUND

Multilayer neural networks (MNN) are widely applied to the fields such as pattern recognition, image processing, functional approximation, and optimal computation. In recent years, due to the higher recognition accuracy and better parallelizability, multilayer artificial neural networks have received increasing attention by academic and industrial communities.

In addition, neural network data include data in different formats and of different lengths. Conventionally, a general-purpose processor, e.g., a CPU, or a graphic processing unit may be implemented for neural network processing. However, the conventional devices may be limited to processing data of a single format. The instruction set for the conventional devices may also be limited to processing data of the same length. With respect to data of different lengths, one or more instructions may be executed; alternatively, one instruction may be repetitively executed, which may lead to unnecessarily long instruction queues and may result in lower system efficiency.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example apparatus for processing data segments in neural networks. The example apparatus may include a computation module capable of performing operations between two vectors in accordance with one or more instructions. Each of the two vectors includes at most a count of multiple reference elements. The example apparatus may further include a data input/output (I/O) module configured to receive neural network data formatted in a first vector and a second vector. The first vector may include multiple first elements and the second vector may include multiple second elements. The data I/O module may be further configured to determine that at least one of a count of the first elements or a count of the second element is greater than the count of the reference elements. The example apparatus may further include a data adjustment module configured to respectively divide the first vector and the second vector into one or more first segments and one or more second segments and transmit the one or more first segments and the one or more second segments to the computation module. The computation module may then be configured to respectively perform the operations between the one or more first segments and the one or more second segments.

Another example aspect of the present disclosure provides an exemplary method for processing data segments in neural networks. The example method may include receiving, by a data I/O module, neural network data formatted in a first vector and a second vector. The first vector may include multiple first elements and the second vector may include multiple second elements. The example method may further include determining, by the data I/O module, that at least one of a count of the first elements or a count of the second element is greater than a threshold count. Further still, the example method may include respectively dividing, by a data adjustment module, the first vector and the second vector into one or more first segments and one or more second segments. In addition, the example method may include transmitting, by the data adjustment module, the one or more first segments and the one or more second segments to a computation module. The computation module may be capable of performing operations between two vectors in accordance with one or more instructions. Each of the two vectors includes at most a count of multiple reference elements. The count of the reference elements is equal to the threshold count. The example method may further include respectively performing, by the computation module, the operations between the one or more first segments and the one or more second segments.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of an example neural network acceleration processor by which data segmentation may be implemented;

FIG. 2 illustrates a block diagram of an example computation module by which data segmentation may be implemented;

FIG. 3A illustrates an example operation between data segments;

FIG. 3B illustrates another example operation between data segments; and

FIG. 4 illustrates a flow chart of an example method for processing neural network data.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or,” which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

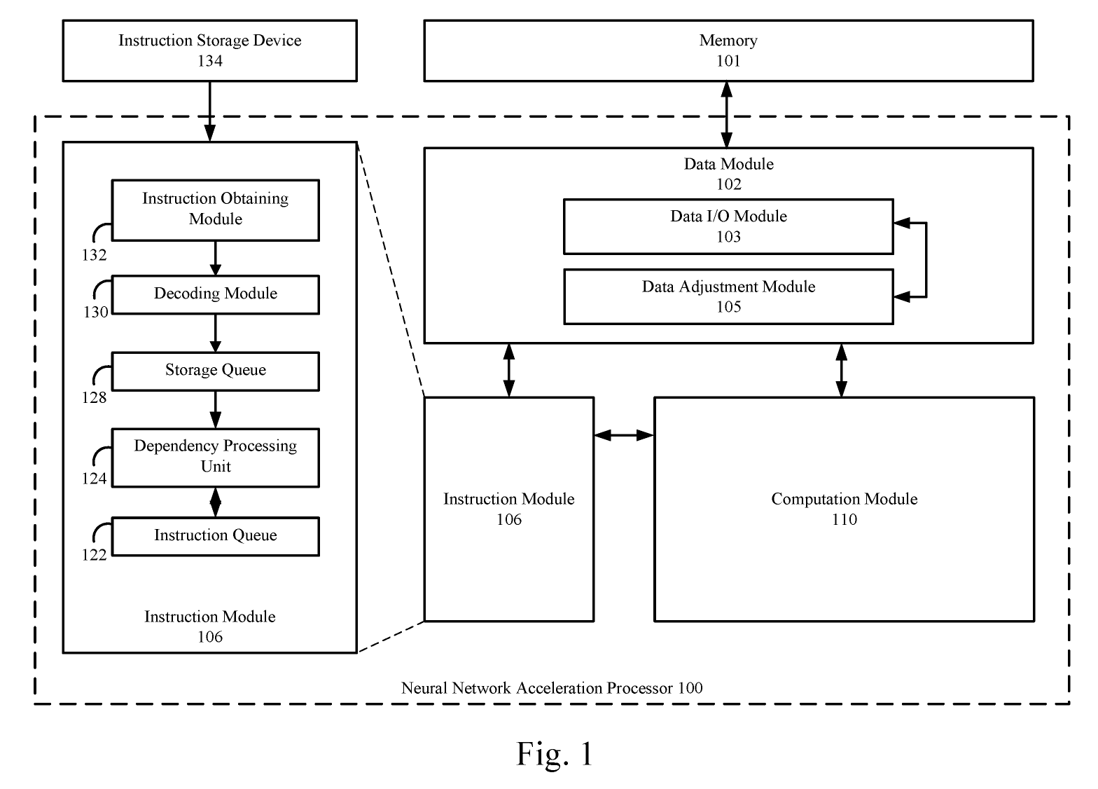

FIG. 1 illustrates a block diagram of an example neural network acceleration processor 100 by which data segmentation may be implemented.

As depicted, the example neural network acceleration processor 100 may include a data module 102, an instruction module 106, and a computation module 110. In general, the data module 102 may be configured to retrieve neural network data from an external storage device, e.g., a memory 101. The instruction module 106 may be configured to receive instructions that specify operations to be performed on the retrieved data from an instruction storage device 134, which may also refer to an external device. Upon receiving instructions from the instruction module 106 and data from the data module 102, the computation module 110 may be configured to process the data in accordance with the received instructions. Any of the above-mentioned components or devices included therein may be implemented by a hardware circuit (e.g., application specific integrated circuit (ASIC), Coarse-grained reconfigurable architectures (CGRAs), field-programmable gate arrays (FPGAs), analog circuits, memristor, etc.).

In more detail, the instruction storage device 134 external to the neural network acceleration processor 100 may be configured to store one or more instructions to process neural network data. The instruction module 106 may include an instruction obtaining module 132 configured to receive one or more instructions from the instruction storage device 134 and transmit the one or more instructions to a decoding module 130.

The decoding module 130 may be configured to decode the one or more instructions respectively into one or more micro-instructions. Each of the one or more instructions may include one or more opcodes that respectively indicate one operation to be performed to a set of neural network data. The decoded instructions may then be temporarily stored by a storage queue 128.

The decoded instructions may then be transmitted from the storage queue 128 to a dependency processing unit 124. The dependency processing unit 124 may be configured to determine whether at least one of the instructions has a dependency relationship with the data of the previous instruction that is being executed. The one or more instructions may be stored in the storage queue 128 until there is no dependency relationship with the data with the previous instruction that has not finished executing. The dependency relationship may refer to a conflict between data blocks that the instructions rely upon. For example, a dependency relationship may exist between two instructions when the two instructions instruct the computation module 110 to perform operations on two overlapping data blocks. If no dependency relationship exists, the decoded instructions may be transmitted to an instruction queue 122 and further delivered to the computation module 110 sequentially.

In some respects, the data module 102 may be configured to receive neural network data from the memory 101. The neural network data may be in a form of vectors that respectively includes one or more elements. An element hereinafter may refer to a value represented in a predetermined number of bits. For example, a vector may include four elements, e.g., values, each of which may be represented in 16 bits. As described previously, the vectors may include different counts of elements. The count of elements included in a vector may be referred to as the length of the vector.

The computation module 110, however, may only be capable of processing vectors that include at most a predetermined count of elements (referred to as “reference elements” hereinafter). In some examples, the computation module 110 may be capable of performing addition operations between vectors that include at most four elements. As such, the data module 102 may be first configured to determine whether the received vectors include more elements than the computation module 110 can process, e.g., the count of the reference elements. If the elements included in the vectors do not exceed the predetermined count of reference elements that the computation module 110 can process, the vectors may be transmitted by the data module 102 to the computation module 110 directly for further processing. If the data module 102 determines that at least one of the vectors include more elements than the reference elements, the data module 102 may be configured to divide the at least one vectors into shorter segments. Each of the segments may include elements less than or equal to the reference elements. The segments may be transmitted to the computation module 110 in pairs sequentially.

In more detail, the data module 102 may include a data I/O module 103 and a data adjustment module 105. The data I/O module 103 may be configured to receive a first vector and a second vector from the memory 101. The data I/O module 103 may be configured to determine if the first vector or the second vector, or both, includes more elements than the reference elements. The data adjustment module 105 may be configured to temporarily store the first vector and the second vector. Further, the data adjustment module 105 may be configured to divide the vector, which includes more elements than the reference elements, into one or more segments.

For example, the computation module 110 may be capable of performing operations between two vectors that each includes at most four elements. The received first vector may include three elements, e.g., A1, A2, and A3. The received second vector may include two elements, e.g., B1 and B2. Since the elements in the first vector and the second vector are less than the count of the reference elements, the first vector and the second vector may be directly transmitted to the computation module 110 for processing.

In an example where the data I/O module 103 receives a first vector that includes five elements (e.g., A1, A2, A3, A4, and A5) and a second vector that also includes five elements (e.g., B1, B2, B3, B4, and B5), the data adjustment module 105 may be configured to divide the first vector into a first segment D1 (e.g., A1, A2, A3, and A4) a second segment D2 (e.g., A5) and to divide the second vector into a third segment D3 (e.g., B1, B2, B3, and B4)) and a fourth segment D4 (e.g., B5). The segments may be transmitted to the computation module 110 in pairs. For example, the first segment D1 and the third segment D3 may be first transmitted the computation module 110 and, subsequently, the second segment D2 and the fourth segment D4 may be transmitted to the computation module 110.

In some other examples, the elements in the segments may be otherwise determined, e.g., by a system administrator, as long as the elements in each segment are less than the count of the reference elements. For example, the first segment may include three elements (e.g., A1, A2, and A3) and the second segment may include two elements (e.g., A4 and A5).

In another example where the first vector includes multiple elements and may be divided into three segments (e.g., D1, D2, and D3) and the second vector may be divided into two segments (e.g., D4 and D5), the segments may be transmitted to the computation module 110 in three pairs. For instance, the segments D1 and D4, D2 and D5, and D3 and D4 may be transmitted to the computation module 110 sequentially in pairs.

In summary, when both the first vector and the second vector may be divided into segments, if the count of segments of the first vector is equal to the count of segments, the segments of the first vector and the segments of the second vector may be paired correspondingly based on the positions of the segments in the first vector and the second vector. If the count of segments of one vector is greater than the count of segments of another vector, the vector that includes more segments may be referred to as “the longer vector” and the vector that includes fewer segments may be referred to as “the shorter vector.” The segments of the longer vector may be sequentially retrieved, and the segments of the shorter vector may be cyclically retrieved to be paired with the segments of the longer vector.

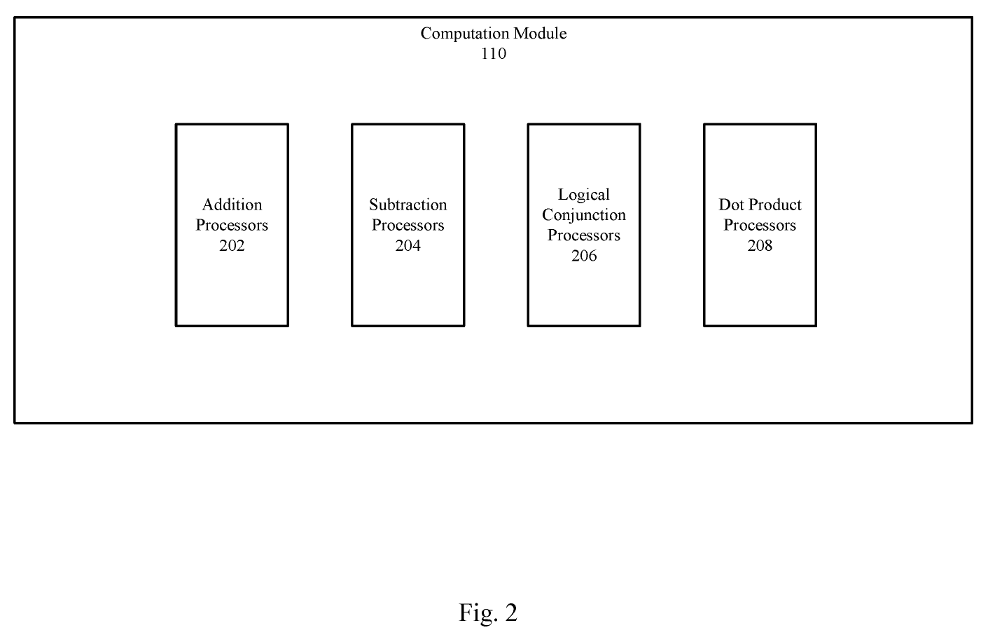

FIG. 2 illustrates a block diagram of an example computation module 110 by which data segmentation may be implemented.

As depicted, the computation module 110 may include one or more addition processors 202, one or more subtraction processors 204, one or more logical conjunction processors 206, and one or more dot product processors 208. The addition processors 202 may be configured to respectively add two vectors to generate a sum vector. The subtraction processors 204 may be configured to respectively subtract one vector from another vector to generate a subtraction result vector. The logical conjunction processors 206 may be configured to perform logical conjunction operations between two vectors. The dot product processors 208 may be configured to calculate a dot product between two vectors.

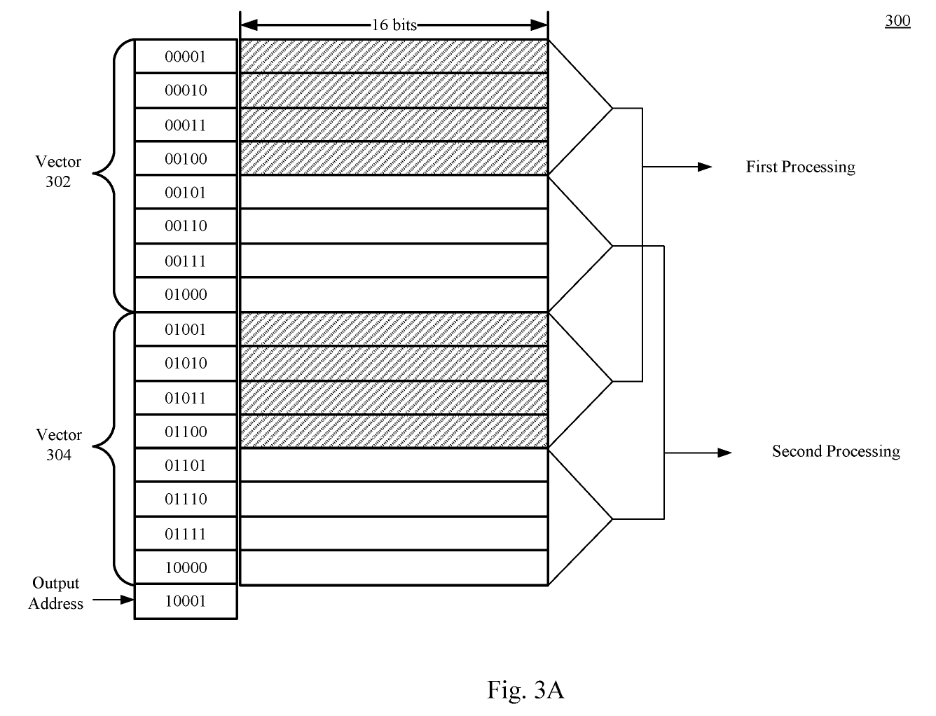

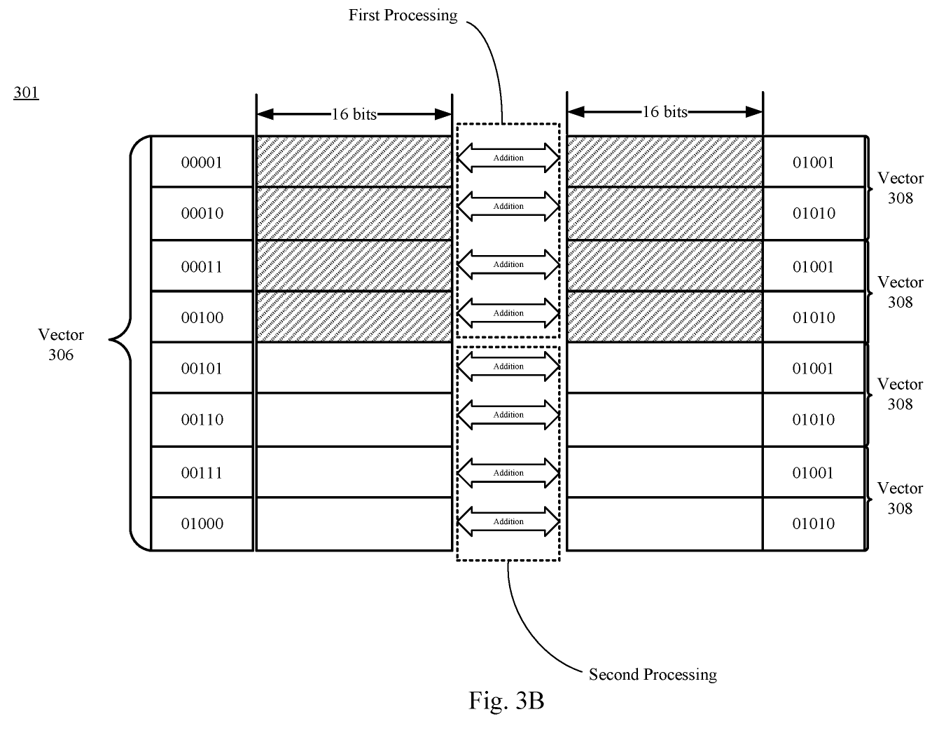

FIG. 3A illustrates an example operation 300 between data segments. The example operation 300 may be initiated in response to a vector-AND-vector (VAV) instruction that instructs the computation module 110 to perform logical conjunction operations between two vectors. The VAV instruction may be formatted as follows:

TABLE 1

| Opcode | Field 1 | Field 2 | Field 3 | Field 4 | Field 5 |
|---|---|---|---|---|---|
| VAV | The starting | Length of | The starting | Length of | Output |
| | address of a | the first | address of a | the second | address |
| | first vector | vector | second vector | vector | |

That is, the VAV instruction may include an opcode that indicates the operation to be performed by the computation module 110, a first field that indicates a starting address of a first vector, a second field that indicates a length of the first vector, a third field that indicates a starting address of a second vector, a fourth field that indicates a length of the second vector, and an output address.

In some examples, the instruction obtaining module 132 may be configured to receive the VAV instruction from the instruction storage device 134. The VAV instruction may be further transmitted to the decoding module 130. The decoding module 130 may be configured to decode the VAV instruction to determine the opcode and the fields in the VAV instruction. For example, anon-limiting example of the VAV instruction may be VAV 00001 01000 01001 01000 10001. The decoded VAV instruction may be transmitted to the storage queue 128.

While the decoded VAV instruction is temporarily stored in the storage queue 128, the data I/O module 103 may be configured to retrieve data based on the fields in the VAV instruction. For example, the data I/O module 103 may retrieve the data stored in 8 addresses from the starting address 00001 as the data of vector 302 and the data stored in another 8 addresses from the starting address 01001 as the data of vector 304.

Based on the retrieved data, the dependency processing unit 124 may be configured to determine whether the VAV instruction and a previously received instruction have a dependency relationship. If not, the VAV instruction may be transmitted to the computation module 110.

The data I/O module 103 may be configured to store the retrieved data in the data adjustment module 105. The data adjustment module 105 may be configured to divide the retrieved data into segments based on the capability of the computation module 110. In some examples, the computation module 110 may include four logical conjunction processors 206. Each logical conjunction processor may be capable of performing logical conjunction operations between two blocks of 16 bits data.

As such, the data adjustment module 105 may be configured to divide the vector 302 and the vector 304 respectively into two segments. Each segment includes four data blocks of 16 bits.

In more detail, the first segment of vector 302, e.g., from address 00001 to address 00100, and the first segment of vector 304, e.g., from address 01001 to address 01100, may be first transmitted to the logical conjunction processors 206. When the logical conjunction processors 206 generate the results between the segments, the data adjustment module 105 may be configured to transmit the second segment of vector 302, e.g., from address 00101 to address 01000, and the second segment of vector 304, e.g., from address 01101 to address 10000, to the logical conjunction processors 206. The results may be transmitted and stored in the output address specified in the VAV instruction, e.g., address 10001.

FIG. 3B illustrates another example operation 301 between data segments. The example operation 301 may be initiated in response to a vector-addition (VA) instruction that instructs the computation module 110 to perform addition operations between two vectors. The VA instruction may be formatted as follows:

TABLE 2

| Opcode | Field 1 | Field 2 | Field 3 | Field 4 | Field 5 |
|---|---|---|---|---|---|
| VA | The starting | Length of | The starting | Length of | Output |
| | address of a | the first | address of a | the second | address |
| | first vector | vector | second vector | vector | |

That is, the VA instruction may include an opcode that indicates the operation to be performed by the computation module 110, a first field that indicates a starting address of a first vector, a second field that indicates a length of the first vector, a third field that indicates a starting address of a second vector, a fourth field that indicates a length of the second vector, and an output address.

In some examples, the instruction obtaining module 132 may be configured to receive the VA instruction from the instruction storage device 134. The VA instruction may be further transmitted to the decoding module 130. The decoding module 130 may be configured to decode the VA instruction to determine the opcode and the fields in the VA instruction. For example, a non-limiting example of the VA instruction may be VA 00001 01000 01001 00010 10001. The decoded VA instruction may be transmitted to the storage queue 128.

While the decoded VA instruction is temporarily stored in the storage queue 128, the data I/O module 103 may be configured to retrieve data based on the fields in the VA instruction. For example, the data I/O module 103 may retrieve the data stored in 8 addresses from the starting address 00001 as the data of vector 306 and the data stored in another 2 addresses from the starting address 01001 as the data of vector 308.

Based on the retrieved data, the dependency processing unit 124 may be configured to determine whether the VA instruction and a previously received instruction have a dependency relationship. If not, the VA instruction may be transmitted to the computation module 110.

The data I/O module 103 may be configured to store the retrieved data in the data adjustment module 105. The data adjustment module 105 may be configured to divide the retrieved data into segments based on the capability of the computation module 110. In some examples, the computation module 110 may include four addition processors 202. Each addition processor may be capable of performing addition operations between two blocks of 16 bits data.

Since the vector 306 includes more elements than the reference elements and the vector 308 includes fewer elements than the reference elements, the data adjustment module 105 may be configured to divide vector 306 into two segments. Thus, the first segment of vector 306, e.g., from address 00001 to address 00100, and the vector 308 may be transmitted to the addition processors 202.

The addition processors 202 may be configured to add the first segment of vector 306 to the vector 308. As the vector 308 only includes two data blocks of 16 bits, the addition processors 202 may be configured to duplicate the vector 308 such that the two vectors are aligned.

Similarly, after the addition results between the first segment of vector 306 and vector 308 are generated, the data adjustment module 105 may be configured to transmit the second segment of vector 306, e.g., from address 00110 to address 01000, and the vector 308 to the addition processors 202. The addition processors 202 may be configured to duplicate vector 308 and respectively add the data blocks together.

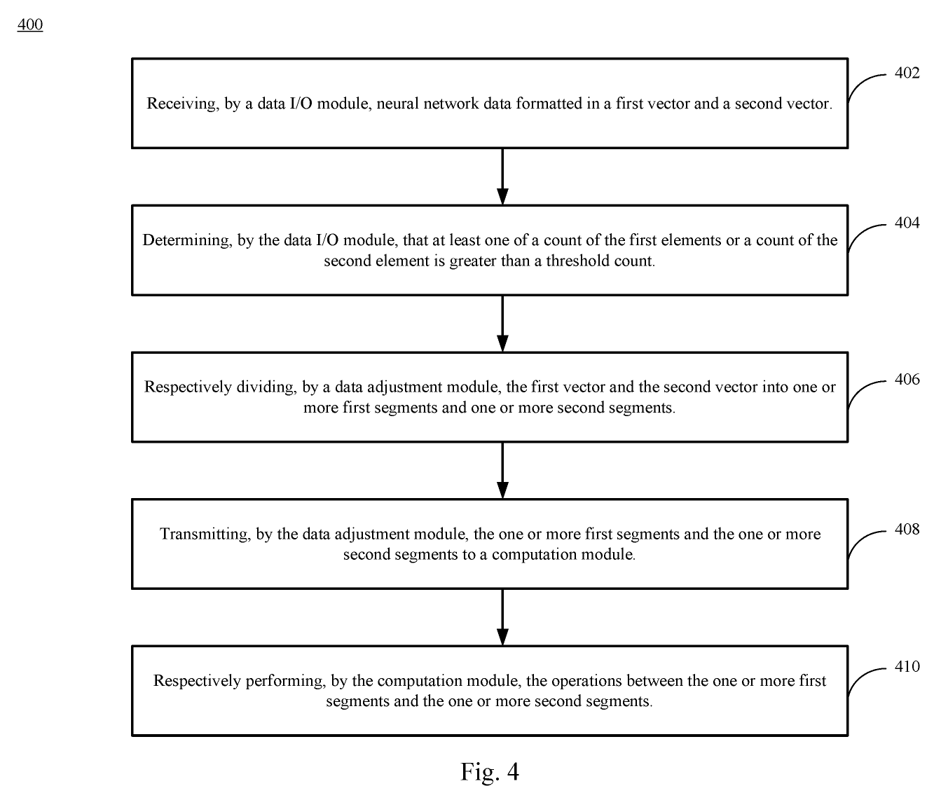

FIG. 4 illustrates a flow chart of an example method 400 for processing neural network data. The example method 400 may be performed by one or more components of the apparatus of FIGS. 1 and 2.

At block 402, the example method may include receiving, by a data I/O module, neural network data formatted in a first vector and a second vector. For example, the data I/O module 103 may be configured to receive a first vector and a second vector from the memory 101. The first vector may include one or more first elements and the second vector may include one or more second elements. Each element may refer to a data block stored in an address.

At block 404, the example method may include determining, by the data I/O module, that at least one of a count of the first elements or a count of the second element is greater than a threshold count. The threshold count may refer to a maximum number of reference elements that the computation module 110 can process. For example, the data I/O module 103 may be configured to determine if the first vector or the second vector, or both, includes more elements than the reference elements. For example, the first vector may include eight elements referring to data stored in eight addresses but the computation module 110 can only process operations between four data blocks.

At block 406, the example method may include respectively dividing, by a data adjustment module, the first vector and the second vector into one or more first segments and one or more second segments. For example, the data adjustment module 105 may be configured to divide the vector, which includes more elements than the reference elements, into one or more segments. In an example where the data I/O module 103 receives a first vector that includes five elements (e.g., A1, A2, A3, A4, and A5) and a second vector that also includes five elements (e.g., B1, B2, B3, B4, and B5), the data adjustment module 105 may be configured to divide the first vector into a first segment D1 (e.g., A1, A2, A3, and a second segment D2 and to divide the second vector into a third segment D3 and a fourth segment D4.

At block 408, the example method may include transmitting, by the data adjustment module, the one or more first segments and the one or more second segments to a computation module. For example, when both the first vector and the second vector may be divided into segments, if the count of segments of the first vector is equal to the count of segments, the segments of the first vector and the segments of the second vector may be paired correspondingly based on the positions of the segments in the first vector and the second vector. If the count of segments of one vector is greater than the count of segments of another vector, the vector that includes more segments may be referred to as “the longer vector” and the vector that includes fewer segments may be referred to as “the shorter vector.” The segments of the longer vector may be sequentially retrieved, and the segments of the shorter vector may be cyclically retrieved to be paired with the segments of the longer vector.

At block 410, the example method may include respectively performing, by the computation module, the operations between the one or more first segments and the one or more second segments. For example, as described in FIG. 3A, the logical conjunction processors 206 may be configured to perform logical conjunction operations between the first segment of vector 302, e.g., from address 00001 to address 00100, and the first segment of vector 304, e.g., from address 01001 to address 01100.

The process or method described in the above accompanying figures can be performed by process logic including hardware (for example, circuit, specific logic etc.), firmware, software (for example, a software being externalized in a non-transitory computer-readable medium), or the combination of the above two. Although the process or method is described above in a certain order, it should be understood that some operations described may also be performed in different orders. In addition, some operations may be executed concurrently rather than in order.

In the above description, each embodiment of the present disclosure is illustrated with reference to certain illustrative embodiments. Apparently, various modifications may be made to each embodiment without going beyond the wider spirit and scope of the present disclosure presented by the affiliated claims. Correspondingly, the description and accompanying figures should be understood as illustration only rather than limitation. It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. An apparatus for neural network processing, comprising:
a computation module capable of performing operations between two vectors in accordance with one or more instructions, wherein each of the two vectors includes at most a count of multiple reference elements;
a data input/output (I/O) module configured to:
receive neural network data formatted in a first vector and a second vector,
wherein the first vector includes multiple first elements, and
wherein the second vector includes multiple second elements, and
determine that at least one of a count of the first elements or a count of the second element is greater than the count of the reference elements; and
a data adjustment module configured to:
respectively divide the first vector and the second vector into one or more first segments and one or more second segments, and
transmit the one or more first segments and the one or more second segments to the computation module, wherein the computation module is configured to respectively perform the operations between the one or more first segments and the one or more second segments.

2. The apparatus of claim 1, wherein a count of elements in each of the first segments and the second segments is equal to or less than the count of the reference elements.

3. The apparatus of claim 1, wherein the data adjustment module is configured to transmit one of the first segments and one of the second segments as a pair to the computation module each time.

4. The apparatus of claim 1, wherein the computation module includes at least one of one or more addition processors, one or more subtraction processors, one or more logical conjunction processors, or one or more dot product processors.

5. The apparatus of claim 1, wherein each of the first elements and the second elements is a value represented in a predetermined number of bits.

6. The apparatus of claim 1, further comprising an instruction obtaining module configured to obtain the one or more instructions from an instruction storage device.

7. The apparatus of claim 6, further comprising a decoding module configured to decode each of the one or more instructions into respective one or more micro-instructions.

8. The apparatus of claim 7, further comprising an instruction queue module configured to store the one or more micro-instructions.

9. The apparatus of claim 8, further comprising a dependency processing unit configured to determine whether at least one of the one or more instructions has a dependency relationship with a previously received instruction.

10. The apparatus of claim 9, further comprising a storage queue module configured to store the one or more instructions while the dependency processing unit is determining an existence of the dependency relationship.

11. A method for neural network processing, comprising:
receiving, by a data I/O module, neural network data formatted in a first vector and a second vector,
wherein the first vector includes multiple first elements, and
wherein the second vector includes multiple second elements;
determining, by the data I/O module, that at least one of a count of the first elements or a count of the second element is greater than a threshold count;
respectively dividing, by a data adjustment module, the first vector and the second vector into one or more first segments and one or more second segments;
transmitting, by the data adjustment module, the one or more first segments and the one or more second segments to a computation module,
wherein the computation module is capable of performing operations between two vectors in accordance with one or more instructions,
wherein each of the two vectors includes at most a count of multiple reference elements, and
wherein the count of the reference elements is equal to the threshold count; and
respectively performing, by the computation module, the operations between the one or more first segments and the one or more second segments.

12. The method of claim 11, wherein a count of elements in each of the first segments and the second segments is equal to or less than the count of the reference elements.

13. The method of claim 11, wherein the transmitting includes transmitting one of the first segments and one of the second segments as a pair to the computation module each time.

14. The method of claim 11, wherein the computation module includes at least one of one or more vector addition processors, one or more vector subtraction processors, one or more logical conjunction processors, or one or more dot product processors.

15. The method of claim 11, wherein each of the first elements and the second elements is a value represented in a predetermined number of bits.

16. The method of claim 11, further comprising obtaining, by an instruction obtaining module, the one or more instructions from an instruction storage device.

17. The method of claim 16, further comprising decoding, by a decoding module, each of the one or more instructions into respective one or more micro-instructions.

18. The method of claim 17, further comprising storing, by an instruction queue module, the one or more micro-instructions.

19. The method of claim 18, further comprising determining, by a dependency processing unit, whether at least one of the one or more instructions has a dependency relationship with a previously received instruction.

20. The method of claim 19, further comprising storing, by a storage queue module, the one or more instructions while the dependency processing unit is determining an existence of the dependency relationship.
